(19) United States
(12) Patent Application Publication
(10) Pub. No.: US 2026/0078796 A1
(43) Pub. Date: Mar. 19, 2026

(54) LOCKNUT WITH INSULATOR

(71) Applicant: Fuzhou JJ Industries Limited, Hong kong (CN)

(72) Inventor: Junjie Huang, Fuzhou (CN)

(21) Appl. No.: 19/326,930

(22) Filed: Sep. 12, 2025

(30) Foreign Application Priority Data
Sep. 13, 2024 (CN) 2024222475261

(51) Int. Cl. F16B 39/12

(52) U.S. Cl. CPC F16B 39/12; F16B 2200/93

(57) ABSTRACT

A locknut with insulator includes a body and an insulating sleeve. A side wall of the body includes at least one grounding connection portion, the at least one grounding connection portion is connected to a grounding component, and an inner wall of the body is provided with threads. An upper end of the insulating sleeve extends in a circumferential direction to form an extending portion, the insulating sleeve is attached inside the body with a clearance between the inner wall of body and insulating sleeve, and the extending portion abuts against an upper end of the body and is connected to the upper end of the body through a connecting structure. By connecting the connecting structure with body, there is no need to disassemble it during use, which provides insulation. The disclosure has advantages of insulation and convenient use.

### CROSS-REFERENCE TO RELATED APPLICATION

This application claims priority to Chinese Patent Application No. 202422247526.1, filed on September 13, 2024, which is herein incorporated by reference in its entirety.

### TECHNICAL FIELD

The disclosure relates to the field of locknuts of cable connectors, conduit connectors and threaded conduits, and particularly to a locknut with insulator.

### BACKGROUND

Cable connectors, conduit connectors and threaded conduits are usually fixed to electronic devices through locknuts. Conventional locknuts only perform the most basic function of mechanical fastening. In service, some may experience leakage currents, while others cannot be properly grounded, lacking grounding functionality, so they cannot adequately protect the circuit system or prevent static electricity issues. Moreover, because the locknuts are screwed onto the cable connectors, the conduit connectors, and the threaded conduits, even if the locknuts are fully tightened during installation, they may loosen due to vibration in daily use, posing significant safety hazards.

### SUMMARY

Therefore, it is necessary to provide a locknut with insulator (also referred to as a self-insulating locknut) to solve the problems of leakage, inability to protect circuits against static electricity, and easy loosening of locknuts for the cable connectors, the conduit connectors and the threaded conduits in the related art.

To achieve above purpose, the disclosure provides a locknut with insulator, which includes a body and an insulating sleeve (i.e., the insulator). A side wall of the body includes at least one grounding connection portion, the at least one grounding connection portion is connected to a grounding component, and an inner wall of the body is provided with threads. An upper end surface of the insulating sleeve extends in a radial direction to form an extending portion, the insulating sleeve is attached inside the body with a clearance between the inner wall of the body and the insulating sleeve, and the extending portion abuts against an upper end surface of the body and is connected to the upper end of the body through a connecting structure.

In an embodiment, a lower end surface of the body is provided with snapping teeth equidistantly disposed along a circumference of the body, and each of the snapping teeth includes an anti-loosening surface facing opposite to a tightening direction of the body.

In an embodiment, each of the snapping teeth further includes a scratching surface in line with the tightening direction of the body, and the scratching surface is opposite to the anti-loosening surface and in an inclined setting.

In an embodiment, the grounding component includes a grounding wire, and the grounding wire is connected to the at least one grounding connection portion.

In an embodiment, the grounding component includes a grounding wire and a grounding lug, the grounding lug includes a grounding wire connecting portion, the grounding lug is connected to the at least one grounding connection portion, and the grounding wire is connected to the grounding wire connecting portion.

In an embodiment, the at least one grounding connection portion on the side wall of the body defines a first threaded hole, a first bolt is disposed in the first threaded hole, and the grounding component is fixed to a position of the side wall of the body corresponding to the first threaded hole through the first bolt.

In an embodiment, the extending portion is circular and covers the upper end surface of the body.

In an embodiment, the connecting structure is a detachable connecting structure.

In an embodiment, the detachable connecting structure includes snapping buckles disposed on the extending portion and snapping slots disposed on the upper end surface of the body, and the snapping buckles are snapped into the snapping slots.

In an embodiment, the detachable connecting structure further includes disassemble holes defined at the lower end surface of the body, and the disassemble holes penetrate through bottoms of the snapping slots, respectively.

Compared to the related art, the locknut with insulator described in the above technical solution includes at least one grounding connection portion on the side wall of the body. Consequently, a grounding lug can be mounted on the grounding connection portion, and a grounding wire can then be fastened to the grounding wire connecting portion of the grounding lug, thereby providing superior grounding performance, preventing short circuits in a circuit system, and reducing potential risk of electrostatic damage. The insulating sleeve is provided, and the insulating sleeve is attached inside the body with a clearance between the inner wall of the body and the insulating sleeve. The cable connectors, the conduit connectors and the threaded conduits can be received in this clearance and threadedly engaged with the body, while the insulating sleeve is inserted into cable connectors, conduit connectors and threaded conduits. A cable is then passed through the insulating sleeve, thereby providing reliable insulation and preventing leakage current. During use, there is no need to avoid or remove the insulating sleeve, making operation convenient. Therefore, the locknut with insulator offers excellent insulation and ease of use.

The above description of the disclosure is only an overview of the technical solution of the disclosure. In order to enable those skilled in the art to have a clearer understanding of the technical solution of the disclosure, and to implement it based on the text of the specification and the attached drawings, and to make the above objectives and other objectives, features, and advantages of the disclosure easier to understand, the following description will be made in conjunction with the specific implementation mode and attached drawings of the disclosure.

### BRIEF DESCRIPTION OF DRAWINGS

The attached drawings are only used to illustrate principles, implementation methods, applications, features, and effects of specific embodiments and other related content of the disclosure, and cannot be considered as limitations of the disclosure.

FIG. 1 illustrates a schematic structural diagram of a locknut with insulator according to an embodiment of the disclosure.

FIG. 2 illustrates a schematic structural diagram of the locknut with insulator from an angle according to the embodiment of the disclosure.

FIG. 3 illustrates a schematic structural diagram of a body according to the embodiment of the disclosure.

FIG. 4 illustrates a schematic side view of an insulating sleeve according to the embodiment of the disclosure.

FIG. 5 illustrates a schematic structural diagram of a grounding lug according to the embodiment of the disclosure.

### Description of reference numerals:

1. body; 101. snapping tooth; 1010. anti-loosening surface; 1011. scratching surface; 102. first threaded hole; 103. first bolt; 104. snapping slot; 105. disassemble hole; 106. thread; 107. grounding connection portion; 108. grounding component; 2. insulating sleeve; 200. extending portion; 201. snapping buckle; 3. grounding lug; 300. second threaded hole; 301. second bolt.

### DETAILED DESCRIPTION OF EMBODIMENTS

In order to provide a detailed explanation of the possible application scenarios, technical principles, feasible specific solutions, and the ability to achieve the objectives and effects of the disclosure, the following specific embodiments will be described in conjunction with the attached drawings. The embodiments described in the specification are only intended to provide a clearer explanation of the technical solution of the disclosure, and are therefore provided as examples only, and should not be used to limit the scope of protection of the disclosure.

In the specification, the term “embodiment” signifies that the particular feature, structure, or characteristic described in connection with the embodiment may be included in at least one embodiment of the disclosure. The word “embodiment” appearing at various places in the specification does not necessarily refer to the same embodiment, nor does it specifically define independence or association with any other embodiment. In principle, in the disclosure, as long as there are no technical contradictions or conflicts, the various technical features mentioned in each embodiment can be combined in any way to form corresponding feasible technical solutions.

Unless otherwise defined, the meanings of the technical terms used in the specification are the same as those commonly understood by those skilled in the art to which the disclosure belongs. The use of relevant terms in the specification is only for the purpose of describing specific embodiments, and is not intended to limit the scope of the disclosure.

In the description of the disclosure, the term “and/or” is used to express the logical relationship between objects, indicating three possible relationships: A alone, B alone, and both A and B together. Unless otherwise specified, the symbol “/” in this specification generally denotes an “or” relationship between the associated objects.

In the disclosure, terms such as “first” and “second” are only used to distinguish one entity or operation from another, and do not necessarily require or imply any actual quantity, priority, or order relationship between these entities or operations.

Without further limitation, in the disclosure, the use of “include”, “contain”, “have” or other similar expressions in the statements is intended to encompass non-exclusive inclusion, and these expressions do not exclude the possibility of additional elements being present in the process, method or product that includes the elements in question, so that the process, method or product that includes a series of elements may not only include those limited elements, but also other elements not explicitly listed, or elements inherent to such process, method or product.

Consistent with the understanding in the Examination Guidelines, in the disclosure, the expressions “greater than,” “less than,” and “exceeding” are construed as excluding the stated number, whereas “or more,” “or less,” and “within” are construed as including the stated number. Moreover, in the description of the embodiments of the disclosure, the term “a plurality of” means two or more, including two, and analogous expressions containing “multiple,” such as “multiple groups,” “multiple times,” etc., are understood in the same manner, unless explicitly and specifically defined otherwise.

In the description of the embodiments of the disclosure, spatial terms such as “center,” “longitudinal,” “transverse,” “length,” “width,” “thickness,” “upper,” “lower,” “front,” “rear,” “left,” “right,” “vertical,” “horizontal,” “perpendicular,” “top,” “bottom,” “inner,” “outer,” “clockwise,” “counterclockwise,” “axial,” “radial,” and “circumferential” indicate orientations or positional relationships shown in the specific embodiments or the drawings. These terms are used solely for convenience in describing the embodiments or facilitating the reader’s understanding, and do not imply or suggest that the referenced device or component must have a specific position, orientation, or be constructed or operated in a particular orientation; therefore, they shall not be construed as limiting any embodiment of the disclosure.

Unless otherwise expressly specified or defined, the terms of “mount,” “connect,” “attach,” “fix,” and “provide” as used in the description of the embodiments of the disclosure are to be interpreted broadly. For example, “connected” may denote a fixed connection, a detachable connection, or an integrally formed arrangement; it may be a mechanical connection, an electrical connection, or a communication connection; it may be a direct connection or an indirect connection via an intermediate medium; and it may represent internal communication between two elements or an interactive relationship between two elements. Those skilled in the art may determine the specific meaning of the above terms in the embodiments of the disclosure according to the particular circumstances.

Cable connectors, conduit connectors and threaded conduits are usually fixed to the electronic devices through the locknuts. Conventional locknuts only perform the most basic function of mechanical fastening. In service, some allow leakage currents, others provide poor or no grounding continuity, so they cannot adequately protect the circuit or prevent static build-up. Moreover, because the locknut is screwed onto the cable connectors, the conduit connectors and the threaded conduits, it can work loose under vibration even if fully tightened during installation, creating a significant safety hazard.

Therefore, the disclosure provides a locknut with insulator, commonly used for fastening the cable connectors, the conduit connectors, and the threaded conduits to electronic devices, serving the function of securing and connecting. Moreover, it additionally provides superior grounding performance, preventing short circuits in the circuit system and the potential risk of electrostatic damage. It features anti-loosening and insulation, offering secure and reliable locking and grounding performance while also ensuring insulation.

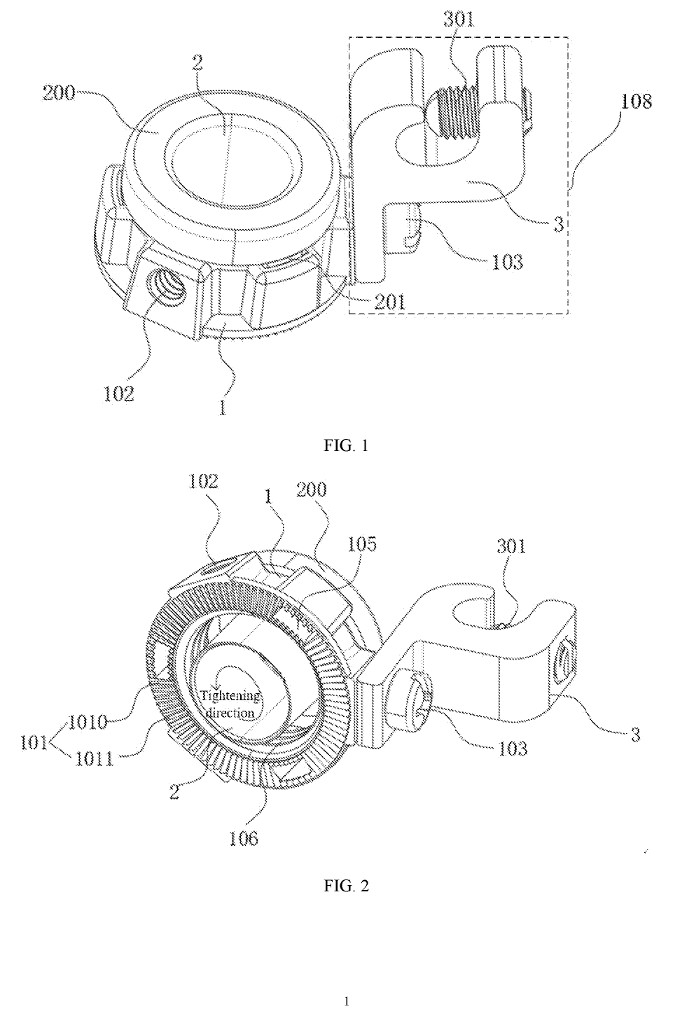

In an embodiment, as shown in FIGS. 1 and 2, locknut with insulator includes a body 1 and an insulating sleeve 2. A side wall of the body 1 includes at least one grounding connection portion 107, the at least one grounding connection portion 107 is connected to a grounding component, and an inner wall of the body 1 is provided with threads 106, which play a role in locking and fixing the cable connectors, the conduit connectors, and the threaded conduits. An upper end surface of the insulating sleeve 2 extends in a radial direction to form an extending portion 200, the insulating sleeve 2 is attached inside the body 1 with a clearance between the inner wall of the body 1 and the insulating sleeve 2, and the extending portion 200 abuts against an upper end surface of the body 1 and is connected to the upper end of the body 1 through a connecting structure.

In the locknut with insulator, the side wall of the body 1 is provided with at least one grounding connection portion 107, the insulating sleeve 2 is attached on the body 1, the insulating sleeve 2 is attached inside the body 1 with a clearance between the insulating sleeve 2 and the body 1. The cable connectors, the conduit connectors, and the threaded conduits can be inserted into the clearance and threadedly engaged with the body 1, and the insulating sleeve 2 is inserted into the cable connectors, the conduit connectors, or the threaded conduits. When a cable is passed through the insulating sleeve 2, reliable insulation is achieved and leakage current is prevented. During use, there is no need to avoid the insulating sleeve 2 or to remove it, making the locknut with insulator highly convenient to use.

As shown in FIG. 2, a lower end surface of the body 1 is provided with snapping teeth 101 equidistantly disposed along a circumference of the body 1, which ensures uniform force distribution. Each of the snapping teeth 101 includes an anti-loosening surface 1010 facing opposite to a tightening direction of the body. This configuration allows the locknut to tighten further under load while preventing loosening due to vibration. Consequently, the locknut with insulator delivers reliable locking and insulation. The snapping teeth 101 are radial teeth distributed along the circumference of body 1, with an angle that configured to tighten the locknut during the locking process and prevent vibration loosening. When subjected to vibration, they can activate the function of preventing loosening.

In an embodiment, each of the snapping teeth 101 further includes a scratching surface 1011 in line with the tightening direction of the body 1, the scratching surface 1011 is opposite to the anti-loosening surface 1010 and in an inclined setting. The scratching surface 1011 can scratch off a surface treatment (such as spraying) on an electrical equipment or housing when the body 1 is locked, so that the locking nut can directly contact the electrical equipment or housing, providing better contact grounding performance.

In an embodiment, the grounding component includes a grounding wire, and the grounding wire is connected to the grounding connection portion 107. Therefore, the traditional cable connectors, the conduit connectors and the threaded conduits with grounding wires can be grounded.

In an embodiment, the grounding component includes a grounding wire and a grounding lug 3, the grounding lug 3 includes a grounding wire connecting portion, the grounding lug 3 is connected to the grounding connection portion 107, and the grounding wire is connected to the grounding wire connecting portion. Thus, the grounding lug 3 can be mounted on the grounding connection portion 107, and the grounding wire can be fastened to the grounding wire connecting portion of the grounding lug 3, thereby delivering superior grounding performance, preventing short circuits in the circuit system, and reducing the potential risk of electrostatic damage. The grounding lug 3 is paired with the body 1 to enhance grounding performance; compared with the traditional practice of directly fastening the grounding wire to the locknut with a bolt, this configuration provides markedly better grounding performance and maintaining excellent grounding continuity.

In an embodiment, as shown in FIG. 1, the grounding connection portion 107 on the side wall of the body 1 defines a first threaded hole 102, a first bolt 103 is disposed in the first threaded hole 102, and the grounding component is fixed to a position of the side wall of the body 1 corresponding to the first threaded hole 102 through the first bolt 103. Specifically, the grounding lug 3 is provided with an installation hole, and the first bolt 103 passes through the installation hole to install the grounding lug 3 at the position of the side wall of the body 1 corresponding to the first threaded hole 102.

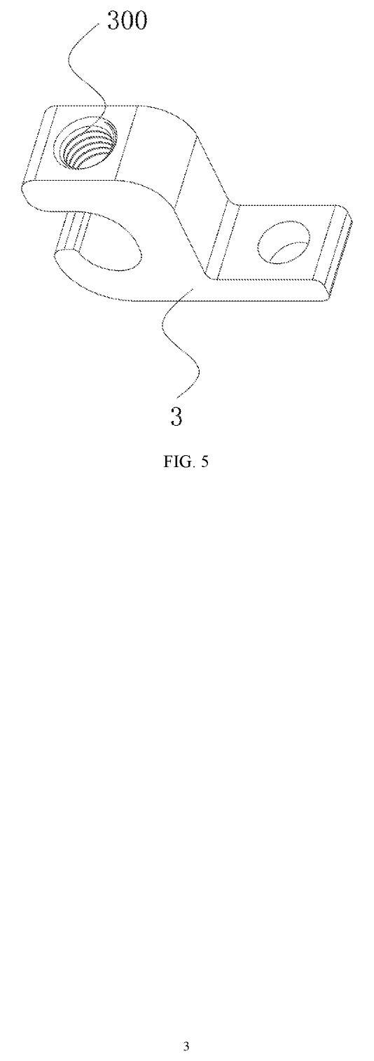

In an embodiment, as shown in FIGS. 1 to 5, the grounding lug 3 defines a second threaded hole 300, and a second bolt 301 is disposed in the second threaded hole 300.

In an embodiment, the grounding lug 3 defines a U-shaped slot, the second threaded hole 300 is formed in the side wall of the U-shaped slot and penetrates through the side wall of the grounding lug 3. The grounding wire can be inserted into the U-shaped slot, after which the second bolt 301 is screwed into the second threaded hole 300 until the grounding wire is clamped firmly within the U-shaped slot.

In an embodiment, at least two grounding connection portions 107 are provided. For example, three grounding connection portions 107 are provided, which are positioned to trisect the circumference of body 1.

In an embodiment, one of the grounding connection portions 107 is connected to a grounding lug 3, while another grounding connection portion 107 is not connected to a grounding lug 3. The grounding wires can be connected either to the grounding wire connecting portion of the grounding lug 3 or directly to a grounding connection portion 107 that is not connected to a grounding lug 3. That is, depending on requirements, the grounding wire may be mounted directly to a grounding connection portion 107 without a grounding lug 3, or the grounding lug 3 may be fastened to the first threaded hole 102 of one grounding connection portion 107 and the grounding wire then fastened to the grounding wire connecting portion of the grounding lug 3, thereby achieving superior grounding performance. The specific configuration can be selected according to actual needs.

In an embodiment, as shown in FIG. 1, the extending portion 200 is circular and covers the upper end surface of the body 1, that is, the extending portion 200 encloses the complete upper end surface of the body 1, providing all-around insulation, which can be regarded that the inner wall of the extending portion 200 is joined to the end of the insulating sleeve 2.

In an embodiment, the connecting structure is a detachable connecting structure, so that a new insulating sleeve 2 can be replaced after aging of the insulating sleeve 2.

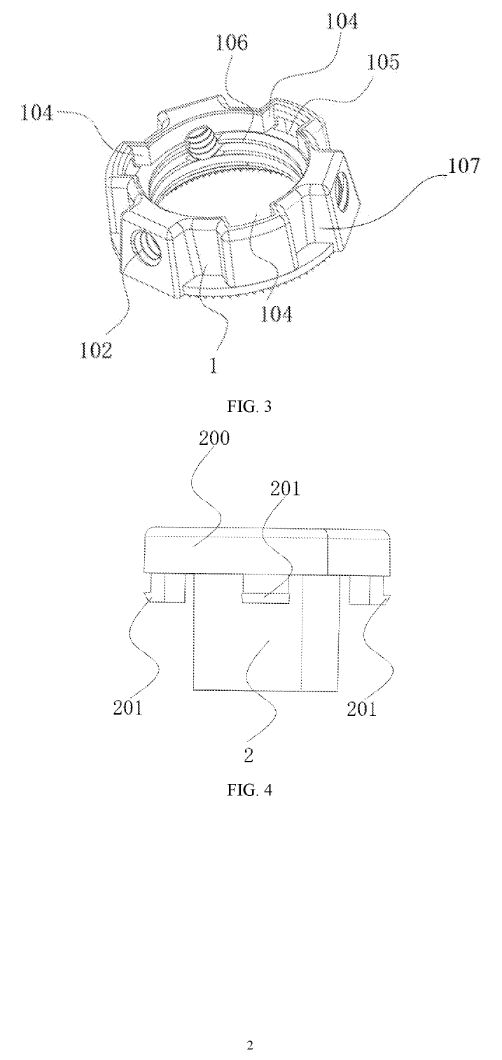

In an embodiment, as shown in FIGS. 3 and 4, the detachable connecting structure can be a snapping structure. The detachable connecting structure includes snapping buckles 201 on the extending portion 200 and snapping slots 104 on the upper end surface of the body 1. The snapping buckles 201 are snapped into the snapping slots 104, so that the insulating sleeve 2 and the body 1 are assembled and fixed together as one unit, eliminating the need for disassembly during use.

In an embodiment, as shown in FIGS. 2 and 3, to facilitate removal and replacement of the insulating sleeve 2, the connecting structure further includes disassemble holes 105 defined on the lower end surface of the body 1. Each disassemble hole 105 penetrates through the bottom of the corresponding snapping slot 104. A user can insert a screwdriver through the disassemble holes 105 to pry the snapping buckles 201, thereby detaching the insulating sleeve 2 from the snapping slots 104.

In an embodiment, the connection structure is provided with three, which divide the circumference of the insulating sleeve 2 into three equal parts, so that the insulating sleeve 2 can be stably installed at the body 1.

In summary, compared with existing products on the market, the disclosure can simultaneously meet a variety of needs under different usage scenarios without the need to remove or avoid the insulating sleeve 2 during installation and fixation, offering convenient installation, superior insulation, and reliable fastening of the cable connectors, the conduit connectors, and the threaded conduits to electronic devices. At the same time, it is equipped with the grounding lug 3, delivering better grounding performance; the radial teeth not only prevent loosening due to vibration but also provide grounding continuity.

Finally, it should be noted that although the above embodiments have been described in the specification and drawings of the disclosure, it does not limit the scope of patent protection of the disclosure. Any technical solution based on the substantive concept of the disclosure, using the equivalent structure or equivalent process recorded in the text and drawings of the disclosure to replace or modify, as well as directly or indirectly implementing the technical solution of the above embodiments in other related technical fields, are included in the scope of patent protection of the disclosure.

What is claimed is:

1. A locknut with insulator, comprising:
a body, wherein a side wall of the body comprises at least one grounding connection portion, the at least one grounding connection portion is connected to a grounding component, and an inner wall of the body is provided with threads; and
an insulating sleeve, wherein an upper end surface of the insulating sleeve extends in a radial direction to form an extending portion, the insulating sleeve is attached inside the body with a clearance between the inner wall of the body and the insulating sleeve, and the extending portion abuts against an upper end surface of the body and is connected to the upper end of the body through a connecting structure.

2. The locknut with insulator as claimed in claim 1, wherein a lower end surface of the body is provided with snapping teeth equidistantly disposed along a circumference of the body, and each of the snapping teeth comprises an anti-loosening surface facing opposite to a tightening direction of the body.

3. The locknut with insulator as claimed in claim 2, wherein each of the snapping teeth further comprises a scratching surface in line with the tightening direction of the body, and the scratching surface is opposite to the anti-loosening surface and in an inclined setting.

4. The locknut with insulator as claimed in claim 1, wherein the grounding component comprises a grounding lug, the grounding lug comprises a grounding wire connecting portion, and the grounding lug is connected to the at least one grounding connection portion.

5. The locknut with insulator as claimed in claim 1, wherein the at least one grounding connection portion on the side wall of the body defines a first threaded hole, a first bolt is disposed in the first threaded hole, and the grounding component is fixed to a position of the side wall of the body corresponding to the first threaded hole through the first bolt.

6. The locknut with insulator as claimed in claim 1, wherein the extending portion is circular and covers the upper end surface of the body.

7. The locknut with insulator as claimed in claim 1, wherein the connecting structure is a detachable connecting structure.

8. The locknut with insulator as claimed in claim 7, wherein the detachable connecting structure comprises snapping buckles disposed on the extending portion and snapping slots disposed on the upper end surface of the body, and the snapping buckles are snapped into the snapping slots.

9. The locknut with insulator as claimed in claim 8, wherein the detachable connecting structure further comprises disassemble holes defined at the lower end surface of the body, and the disassemble holes penetrate through bottoms of the snapping slots, respectively.
